(19) United States
(12) Patent Application Publication
(10) Pub. No.: US 2019/0059517 A1
(43) Pub. Date: Feb. 28, 2019

(54) SHOE TRAINING AID

(71) Applicant: Natalie Milton, Lafayette, LA (US)

(72) Inventor: Natalie Milton, Lafayette, LA (US)

(21) Appl. No.: 15/692,860

(22) Filed: Aug. 31, 2017

(51) Int. Cl. A43B 23/24; A43B 3/00; A43B 1/00; A43B 3/30; G09B 19/00

(52) U.S. Cl. CPC A43B 23/24; A43B 3/0094; G09B 19/0076; A43B 3/30; A43B 1/0054

(57) ABSTRACT

A shoe training aid. The shoe training aid includes a first band and a second band each having an elongated body with a first portion opposite a second portion. The first portion includes a first magnet and the second portion includes a second magnet. The first band is configured to secure to a right shoe so that the first portion is disposed on an inner side of the right shoe and the second portion is disposed on an outer side of the right shoe. The second band is configured to secure to a left shoe so that the first portion is disposed on an inner side of the left shoe and the second portion is disposed on an outer side of the left shoe.

### BACKGROUND OF THE INVENTION

The present invention relates to a shoe training aid and, more particularly, to a shoe training aid that helps young children determine the difference between the right shoe and the left shoe.

Currently, young children have a difficult time determining the difference between a right shoe from a left shoe. This results in young children placing the wrong shoe on the wrong foot.

As can be seen, there is a need for a shoe training aid that helps young children determine the difference between the right shoe and the left shoe.

### SUMMARY OF THE INVENTION

In one aspect of the present invention, a shoe training aid comprises: a first band and a second band each comprising an elongated body having a first portion opposite a second portion, wherein the first portion comprises a first magnet and the second portion comprises a second magnet, wherein the first band is configured to secure to a right shoe so that the first portion is disposed on an inner side of the right shoe and the second portion is disposed on an outer side of the right shoe, the second band is configured to secure to a left shoe so that the first portion is disposed on an inner side of the left shoe and the second portion is disposed on an outer side of the left shoe, and the first magnet of the first band one of repels from and attracts to the first magnet of the second band and the second magnet of the first band the other of repels from and attracts to the second magnet of the second band.

In another aspect of the present invention, a method of making a shoe training aid comprises: attaching a first magnet to an inner side of a right shoe; attaching a second magnet to an outer side of the right shoe; attaching a third magnet to an inner side of a left shoe; and attaching a fourth magnet to an inner side of the left shoe, wherein the first magnet one of repels from and attracts to the third magnet, and the second magnet the other of repels from and attracts to the fourth magnet.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a section view of the present invention taken along line 3-3 in FIG. 2;

FIG. 4 is a detail section view of an embodiment of the present invention;

FIG. 5 is a schematic view of an embodiment of the present invention showing magnets attracting to one another when shoes are arranged correctly;

FIG. 6 is a schematic view of an embodiment of the present invention showing magnets repelling from one another when shoes are arranged incorrectly;

FIG. 7 is a perspective view of an embodiment of the present invention shown in use; and

FIG. 8 is a perspective view of an embodiment of the present invention shown as a pair.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

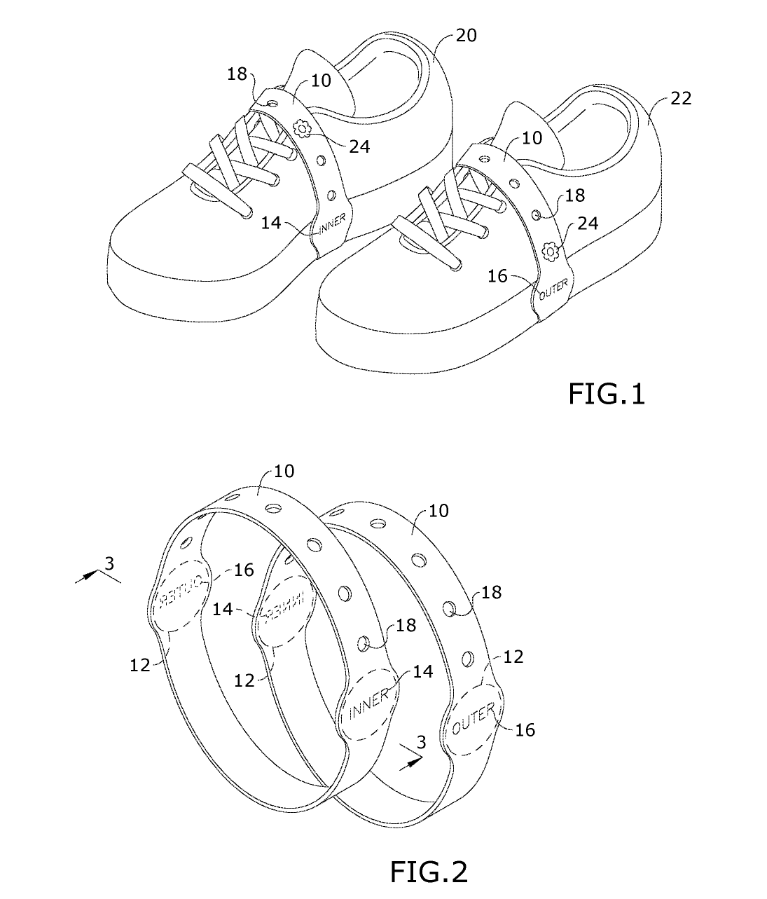

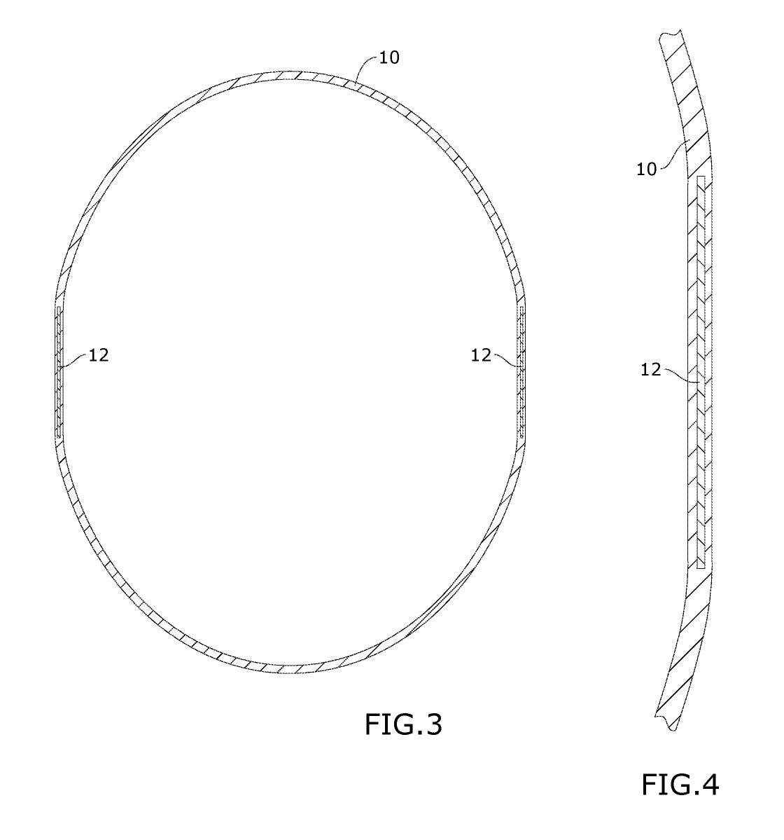

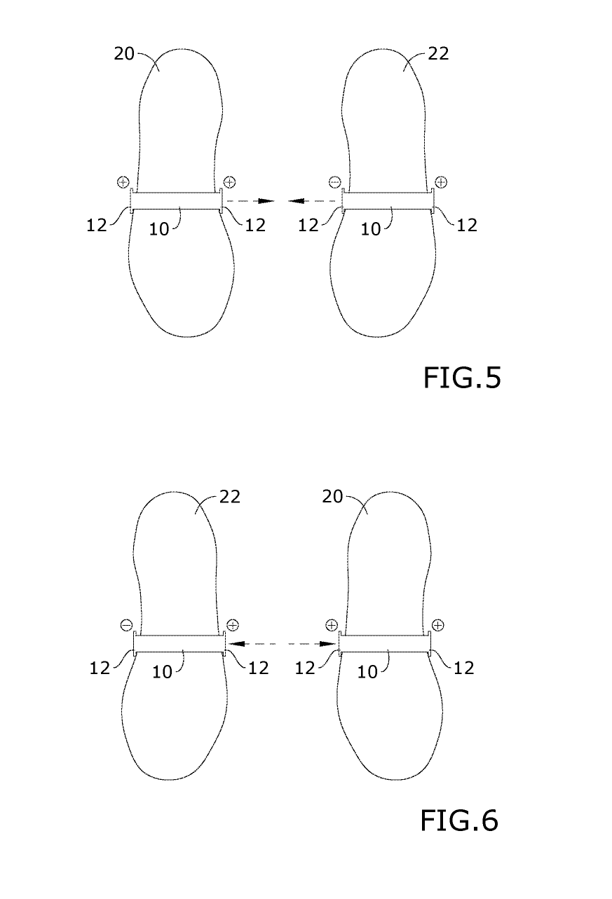

Referring to FIGS. 1 through 6, the present invention includes a shoe training aid. The shoe training aid includes a first band 10 and a second band 10 each having an elongated body with a first portion opposite a second portion. The first portion includes a first magnet 12 and the second portion includes a second magnet 12. The first band 10 is configured to secure to a right shoe 20 so that the first portion is disposed on an inner side of the right shoe 20 and the second portion is disposed on an outer side of the right shoe 20. The second band 10 is configured to secure to a left shoe 22 so that the first portion is disposed on an inner side of the left shoe 22 and the second portion is disposed on an outer side of the left shoe 22.

The magnetic attraction or repellant indicates to the child whether the child has put the shoes 20, 22 on the correct foot. For example, the first magnet 12 of the first band 10 may attract to the first magnet 12 of the second band 10 and the second magnet 12 of the first band 10 may repel from the second magnet 12 of the second band 10. In such embodiments, the attraction of magnets 12 indicates the shoes 20, 22 are on the correct feet and the repelling of the magnets 12 indicates the shoes 20, 22 are on the incorrect feet. Alternatively, the first magnet 12 of the first band 10 may repel from the first magnet 12 of the second band 10 and the second magnet 12 of the first band 10 may attract to the second magnet 12 of the second band 10. In such embodiments, the repelling of magnets 12 indicates the shoes 20, 22 are on the correct feet and the attracting of the magnets 12 indicates the shoes 20, 22 are on the incorrect feet. The positive side of the magnet may be facing the negative side of the magnet to attract and either the negative side may be facing the negative side of the magnet to repel or the positive side may be facing the positive side to repel.

The shoes 20, 22 of the present invention may include any shoe, sandal, boot, sneaker or other types of footwear. The shoe includes an upper and a sole. The upper and the sole each include an inner side, which is the side of the pair of shoes that faces one another, and an outer side, which is the side of the pair of shoes that faces away from one another.

In certain embodiments, the first band 10 and the second band 10 are endless loops configured to wrap around an upper and a sole of the right shoe 20 and the left shoe 22 respectively. In such embodiments, the bands 10 may be made of a material having a rubber elasticity, such as rubber, silicone and the like. Each of the first band 10 and the second band 10 may include a plurality of apertures 18 formed through an upper portion. A decorative attachment 24 may be placed within the apertures 18 to further decorate the shoes 20, 22.

The present invention may indicate which of the first portion and the second portion should be placed on the inner side or the outer side of the shoe 20, 22. For example, a color, number, printed material, design and the like may allow a user to attach the bands 10 so that the magnets 12 are located in a correct position to allow the present invention to work. For example, an outside surface of the first portion of the first band 10 is labeled inner 14 and an outside surface of the second portion of the first band is labeled outer 16. Further, an outside surface of the first portion of the second band 10 is labeled inner 14 and an outside surface of the second portion of the second band 10 is labeled outer 16.

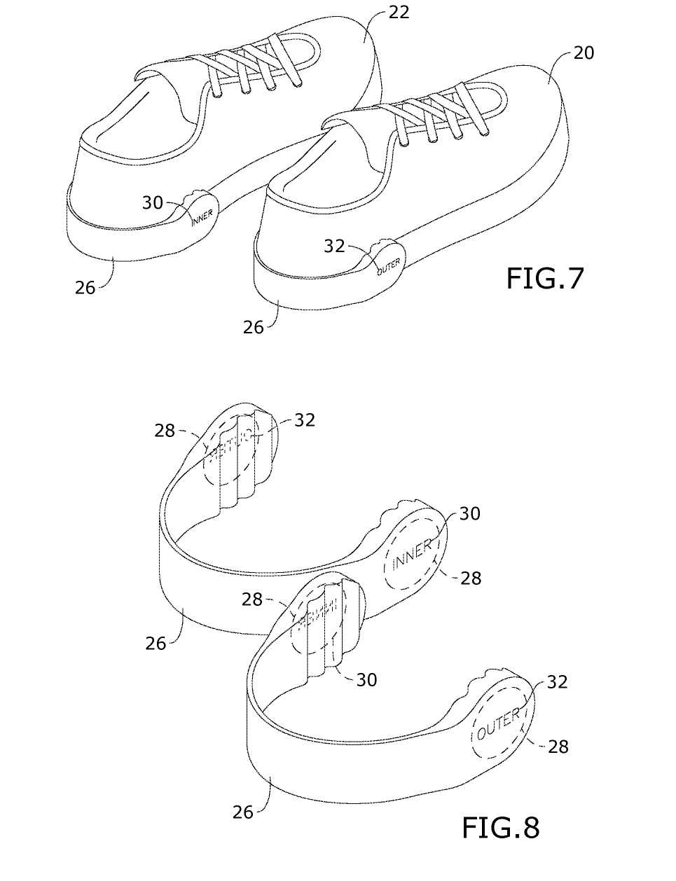

Referring to FIGS. 7 and 8, the shoe training aid may include bands 26 each having first ends including the first portions and second ends including the second portions. In such embodiments, the bands 26 may each be in the form of C-shaped clip that wraps around a heel portion of the right shoe 20 and the left shoe 22 respectively. In such embodiments, the bands 26 may be made of a rigid yet flexible material. For example, the bands 26 may be made of a flexible metal or plastic. Therefore, the bands 26 may snuggly snap onto the backs of the shoes 20, 22. Each of the bands 26 further include magnets 28 and may further include the inner 30 label and the outer 32 label.

The present invention may further include a method of making a training aid. The method may include the following steps: attaching a first magnet to an inner side of a right shoe; attaching a second magnet to an outer side of the right shoe; attaching a third magnet to an inner side of a left shoe; and attaching a fourth magnet to an inner side of the left shoe.

The first magnet may attract to the third magnet and the second magnet may repel the fourth magnet. In such embodiments, the attraction of magnets indicates the shoes are on the correct feet and the repelling of the magnets indicates the shoes are on the incorrect feet. Alternatively, the first magnet may repel from the third magnet and the second magnet may attract to the fourth magnet. In such embodiments, the repelling of magnets indicates the shoes are on the correct feet and the attracting of the magnets indicates the shoes are on the incorrect feet.

The method mentioned above may further include the step of providing the first band and the second band described above. If the first band and the second band are endless loops, the first band and the second band are wrapped around the upper and the heel of each of the shoes. If the first band and the second band are the C-shaped clips, the first band and the second band are snapped onto the heel portions of the shoes.

It should be understood, of course, that the foregoing relates to exemplary embodiments of the invention and that modifications may be made without departing from the spirit and scope of the invention as set forth in the following claims.

What is claimed is:

1. A shoe training aid comprising:
a first band and a second band each comprising an elongated body having a first portion opposite a second portion, wherein the first portion comprises a first magnet and the second portion comprises a second magnet, wherein
the first band is configured to secure to a right shoe so that the first portion is disposed on an inner side of the right shoe and the second portion is disposed on an outer side of the right shoe,
the second band is configured to secure to a left shoe so that the first portion is disposed on an inner side of the left shoe and the second portion is disposed on an outer side of the left shoe, and
the first magnet of the first band one of repels from and attracts to the first magnet of the second band and the second magnet of the first band the other of repels from and attracts to the second magnet of the second band.

2. The shoe training aid of claim 1, wherein the first magnet of the first band attracts to the first magnet of the second band and the second magnet of the first band repels from the second magnet of the second band.

3. The shoe training aid of claim 1, wherein each of the first band and the second band are endless loops configured to wrap around an upper and a sole of the right shoe and the left shoe respectively.

4. The shoe training aid of claim 3, wherein each of the first band and the second band comprise a plurality of apertures through an upper portion each configured to receive and retain a decorative attachment.

5. The shoe training aid of claim 1, wherein each of the first band and the second band comprise a first end comprising the first portion and a second end comprising the second portion, wherein the first band and the second band are configured to wrap around a heel portion of the right shoe and the left shoe respectively.

6. The show training aid of claim 1, wherein an outside surface of the first portion of the first band is labeled inner and an outside surface of the second portion of the first band is labeled outer, wherein an outside surface of the first portion of the second band is labeled inner and an outside surface of the second portion of the second band is labeled outer.

7. A method of making a shoe training aid comprising:
attaching a first magnet to an inner side of a right shoe;
attaching a second magnet to an outer side of the right shoe;
attaching a third magnet to an inner side of a left shoe; and
attaching a fourth magnet to an inner side of the left shoe, wherein
the first magnet one of repels from and attracts to the third magnet, and
the second magnet the other of repels from and attracts to the fourth magnet.

8. The method of claim 7, further comprising the step of providing a first band and a second band each comprising an elongated body having a first portion opposite a second portion, wherein the first portion of the first band comprises the first magnet, the second portion of the first band comprises the second magnet, the first portion of the second band comprises the third magnet and the second portion of the second band comprises the fourth magnet.

9. The shoe training aid of claim 8, wherein each of the first band and the second band are endless loops that wrap around an upper and a sole of the right shoe and the left shoe respectively.

10. The shoe training aid of claim 8, wherein each of the first band and the second band comprise a first end comprising the first portion and a second end comprising the second portion, wherein the first band and the second band each wrap around a heel portion of the right shoe and the left shoe respectively.
